(19) United States
(12) Patent Application Publication
(10) Pub. No.: US 2018/0189803 A1
(43) Pub. Date: Jul. 5, 2018

(54) A METHOD AND SYSTEM FOR PROVIDING BUSINESS INTELLIGENCE

(71) Applicant: eRevalue Limited, London (GB)

(72) Inventors: Jean-Philippe LECOURT, London (GB); Jeltje LECOURT-ALMA, London (GB); Jerome BASDEVANT, Valencia (ES)

(21) Appl. No.: 15/736,726

(22) PCT Filed: Jun. 15, 2016
(86) PCT No.: PCT/GB2016/051782

§ 371 Date: Dec. 14, 2017

Related U.S. Application Data
(60) Provisional application No. 62/175,680, filed on Jun. 15, 2015.

(51) Int. Cl. G06Q 30/02; G06Q 10/10

(52) U.S. Cl. CPC G06Q 30/0201; G06Q 10/10

(57) ABSTRACT

The present invention relates to a computer-implemented method of providing business intelligence. The method including the steps of a processor obtaining data from a plurality of sources for each of a plurality of organisations; a processor processing the data using an ontological method to generate a profile for each organisation; and a processor using the profiles of the organisations to generate analysis. A system is also disclosed.

### FIELD OF INVENTION

The present invention is in the field of business intelligence. More particularly, but not exclusively, the present invention relates to a computer-implemented method and system for providing business intelligence.

### BACKGROUND

Business intelligence involves the collection and processing of information for business analysis purposes.

Typical business intelligence technologies enforce internal business processes to capture structured/semi-structured data about the organisation from its employees.

However, organisations have access to vast reservoirs of information that would be useful in business intelligence but because it is unstructured is difficult to effectively utilise.

For example, in the fields of corporate governance and corporate strategy setting, organisation desire intelligence about which topics are of importance and why: due to a regulatory development, stakeholder demands or public opinion or a new industry standard; more specifically companies desire knowledge on how they compare against their competition and peers in addressing issues associated with these topics.

To completely satisfy this desire, information must be collated and processed from unstructured data sources and, at present, such intelligence is provided in an ad-hoc, non-systemic, and predominantly manual method by external/internal advisors (e.g. strategy consultants and legal advisors) who read and process information from multiple sources to generate reports with actionable intelligence for that organisation.

There is a desire for business intelligence which is capable of leveraging a broad variety of data about organisations to provide automated analysis. It is desirable if the data about organisations covers information from multiple angles such as the company perspective and own disclosure, regulatory developments affecting that organisation and public opinion and company's stakeholders issuing concerns. Furthermore, there is a need for analysis to produce business intelligence to be performed based on the current corporate profile for the organisation or a hypothetical corporate profile (e.g. the company after a merger, or of the company's key supplier or customer).

It is an object of the present invention to provide a method and system for providing business intelligence which overcomes the disadvantages of the prior art, or at least provides a useful alternative.

### SUMMARY OF INVENTION

According to a first aspect of the invention there is provided a computer-implemented method of providing business intelligence, including:

a processor obtaining data from a plurality of sources for each of a plurality of organisations;
a processor processing the data using an ontological method to generate a report for each organisation; and
a processor using the reports of the organisations to generate analysis.

The analysis may relate to Financial, Economic, Environmental, Social and/or Governance (ESG) issues.

The analysis may include analysing a profiled organisation against one or more of the plurality of organisations. The one or more of the plurality of organisations may be selected based upon an overlap between the report of the one or more organisations and a profile of the profiled organisation. The overlap may relate to sector and/or geographic overlap. The analysis may be a comparison based upon topic. The method may further include the step of generating a visualisation for a user interface of the analysis and/or creating the profile for the profiled organisation. The profile may include a plurality of weighted relevant topics. The plurality of weighted relevant topics may be created via the ontological method.

The ontological method may include analysis of the data to identify relevant topics. The relevant topics may be weighted by importance.

The ontological method may include the steps of:

at least one processor tokenising text within at least one part of the data; and
at least one processor matching tokenised text against an ontological framework using a plurality of rules to identify relevant topics within the data.

The plurality of sources may include one or more selected from the set of sustainability reports, SEC filings, financial annual reports, integrated reports, and sustainability web-sites.

The method include the step of locating relevant regulatory information for the profiled organisation using the profile of the profile organisation.

The analysis may include benchmarking.

The analysis may include locating relevant organisations by searching within the reports using a user-specified topic.

According to a further aspect of the invention there is provided a system for providing business intelligence for an organisation, including:

A communication module configured to obtain data from a plurality of sources about a plurality of organisations;

At least one processor configured to process data from a plurality of sources using an ontological method to form a report for each organisation and using the reports of the organisations to generate analysis; and

A user device configured to display data related to the analysis to a user.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a flow diagram illustrating an ontological method in accordance with an embodiment of the invention;

FIG. 4: shows a table illustrating a portion of an exemplary ontology for use with an embodiment of the invention;

FIG. 5a: shows a screenshot illustrating an exemplary display of a benchmark analysis in accordance with an embodiment of the invention;

FIG. 5b: shows a screenshot illustrating another exemplary display of a benchmark analysis in accordance with an embodiment of the invention;

FIGS. 6a and 6b:

show screenshots illustrating another exemplary display of a topic-based analysis in accordance with an embodiment of the invention;

FIG. 7: shows a flow diagram illustrating an regulatory information location method in accordance with an embodiment of the invention;

FIG. 8a: shows a screenshot illustrating part of a user interface for constructing a profile for an organisation in accordance with an embodiment of the invention; and

FIG. 8a: shows a screenshot illustrating another part of a user interface for constructing a profile for an organisation in accordance with an embodiment of the invention.

### DETAILED DESCRIPTION OF PREFERRED EMBODIMENTS

The present invention provides a method and system for providing business intelligence.

The inventors have discovered that an ontological framework can be utilised to analyse unstructured data from a plurality of sources to generate reports of organisations. The reports may comprise topics of interest/relevance to the organisation. These reports can then be used to construct analysis by contrasting/benchmarking a profile for an organisation (or a profile representing a scenario for the organisation) against the compiled reports. The reports can be clustered, for example, by sector, geographic location, etc. The analysis may be able to identify significant strengths, weaknesses, opportunities, and threats for the organisation to focus on. The analysis may incorporate Economic, Environmental, Social and Governance (EESG) topics with financial topics to provide holistic approach to corporate strategy. The analysis may comprises insights derived from corporate reports and websites (“the competitive landscape”), regulatory initiatives (“the regulatory landscape”) and (social) media (“the stakeholder/public opinion landscape”).

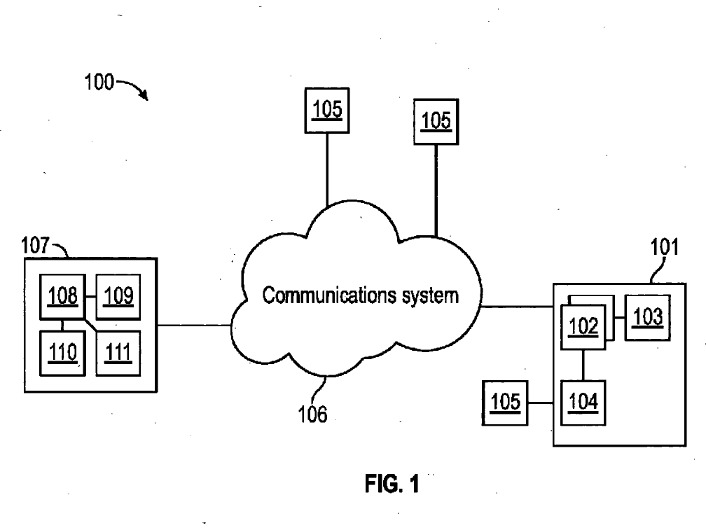

In FIG. 1, a system 100 in accordance with an embodiment of the invention is shown.

A server 101 is shown. The server 101 includes at least one processor 102, a memory 103, and a communications module 104.

It will be appreciated that the server 101 may exist distributed across a plurality of apparatus linked by a communications network or system.

One of the at least one processors 101 are configured to obtain data about organisations from a plurality of sources 105. The plurality of sources may be external or internal.

The communications module 104 may be configured for communicating with one or more of the plurality of sources 105, for example, via a communications system 106 to retrieve the data.

In one embodiment, data from the plurality of sources 105 is collated by the server 101 and stored in the memory 103 for later retrieval.

The data may be obtained using links or URIs (Universal Resource Identifiers) to the data. The links may be stored within the memory 103. The links may be defined manually, automatically or a combination of the two.

One of the at least one processors 102 may be further configured to process the data using an ontological method to generate a report for each of a plurality of organisations.

One of the at least one processors 102 may be further configured to generate analysis using the organisation profiles.

The memory 103 may be configured to store the data, the formed reports, and/or the analysis.

A user device 107 including a processor 108, a memory 109, an input 110 and a display 111 is also shown. The user device 107 may be a computing apparatus such as a desktop, laptop, tablet, or similar. The input 110 may be touch-screen, pointer device, touch-pad, keyboard, or similar, and the display 111 may be a touch-screen, LED/LCD screen, projector, or any other electronic display.

The communications module 104 may also be configured to transmit generated analysis to the user device 107 via, for example, the communications system 106.

The user device 107 may be configured to receive the generated analysis and display it within a user interface to the user via the display 111 and input 110.

The communications system 106 may be a communications network, or combination of networks comprised of wireless (such as wifi or cellular) or wired networks (such as Ethernet).

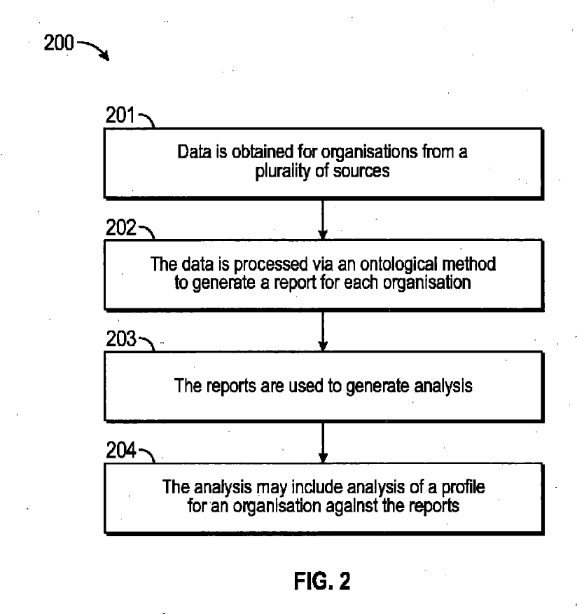

Referring to FIG. 2, a method 200 in accordance with an embodiment of the invention will be described.

In step 201, data is obtained (e.g. via processor 102) for each of a plurality of organisations from a plurality of sources.

Each source may provide data of a specific type. In one embodiment, the different data types include sustainability reports, SEC filings, financial annual report and integrated reports.

Links or URIs may be defined which identify the data or data source. The links may be used to obtain the data.

The links may be created manually, automatically, or a combination of both, and stored (e.g. within the memory).

The data may be pre-fetched and stored in a database such that data is obtained indirectly from the plurality of sources.

In step 202, the data may be processed (e.g. via processor 102) via an ontological method to form a report for each organisation.

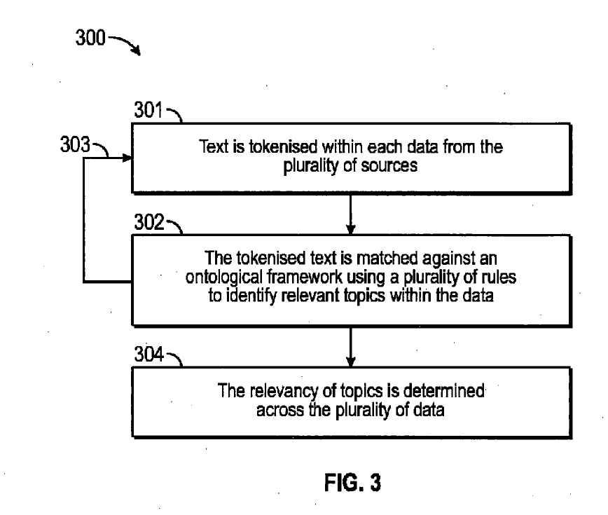

The ontological method may be performed as described in relation to FIG. 3.

As a result of the processing, the report may be comprised of a plurality of relevant topics identified for each organisation. The relevant topics may be weighted as a result of the ontological method to define a level of importance for the relevant topic to the organisation.

In step 203, the reports of the organisations are used to generate analysis.

The analysis may include assessing the relevancy of specific topics in relation to the organisations. For example, a user may select or provide a specific topic and a search may be performed in relation to the organisations to locate which organisations that topic may be relevant for and the extent of its relevancy (i.e. high, medium or low).

In step 204, and in one embodiment of the invention, the analysis may include analysis of a profile for an organisation against one or more of the generated reports.

The method may include the step of constructing the profile for the organisation. The profile may be constructed manually, automatically, or using a combination of both.

The profile may relate to a scenario for the organisation (for example, the profile may represent only an aspect of the organisation, the state of an organisation after implementation of a possible strategy [e.g. merger, part-sale, etc.], or it may represent a supplier for the organisation). In this way, a user can model different possibilities to benchmark or analyse with respect to the generated reports.

The profile may include categorisation of the organisation in relation to several classifications. The classifications may include geographic areas of interest or operation (i.e. location of headquarters, markets served, suppliers located, etc.), and sectors of interest or operation (i.e. sectors served, suppliers sectors, etc.).

The analysis may utilise reports for those organisations that match one or more of the categorisations for the profiled organisation. The one or more categorisations may be specified by the user. These matched organisations may form, for example, a peer group or competitors to the organisation.

The profile may also include selection or generation of a plurality of topics of interest or relevance to the organisation. A weighting may be assigned to each topic. Assigning the weighing may comprise selection of a one of a plurality of weights (for example, high, medium, or low).

The generation of the plurality of topics may occur, at least in part, automatically. The topics may be generated by first obtaining data for the organisation from a plurality of sources (as in step 201), processing the data via an ontological method (e.g. as described in relation to FIG. 3) to generate relevant topics and to assign a weighing (or relevancy) to each topic.

The analysis may include benchmarking of the organisation (in accordance with its profile) against the other organisations.

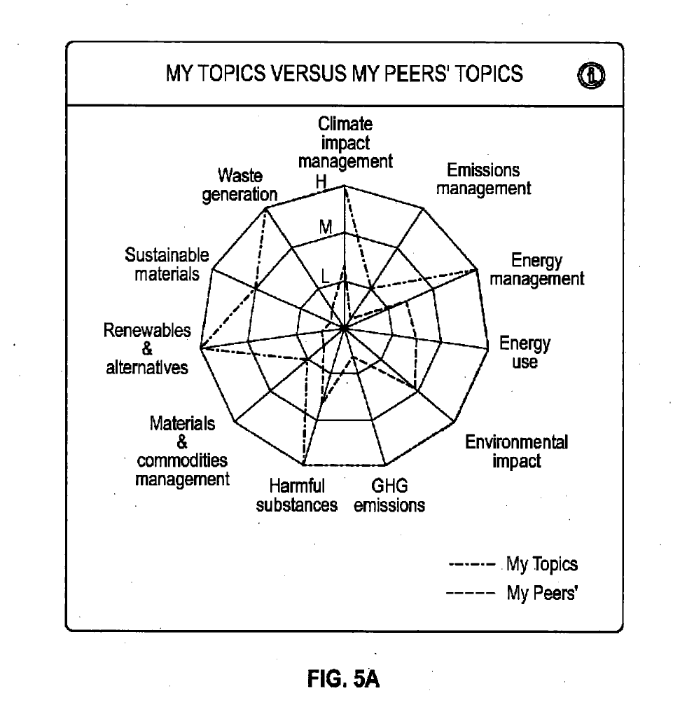

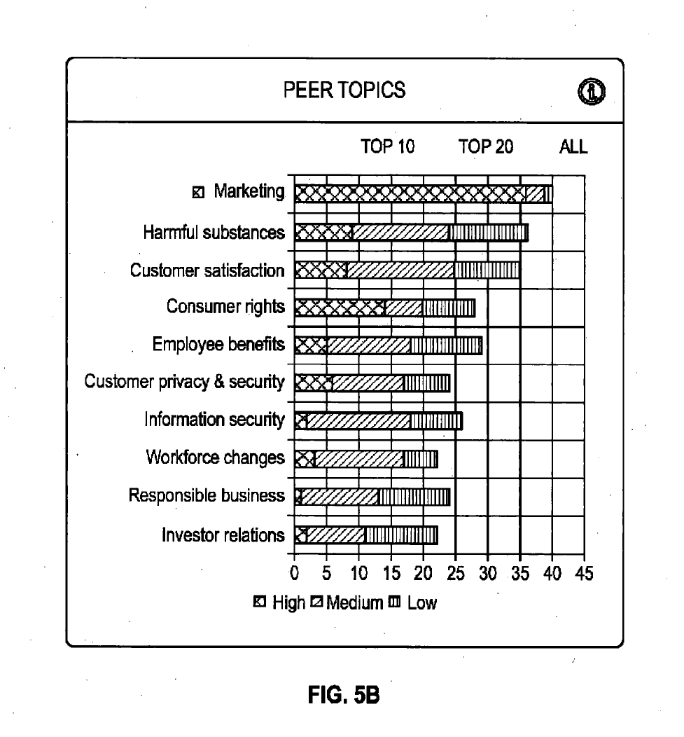

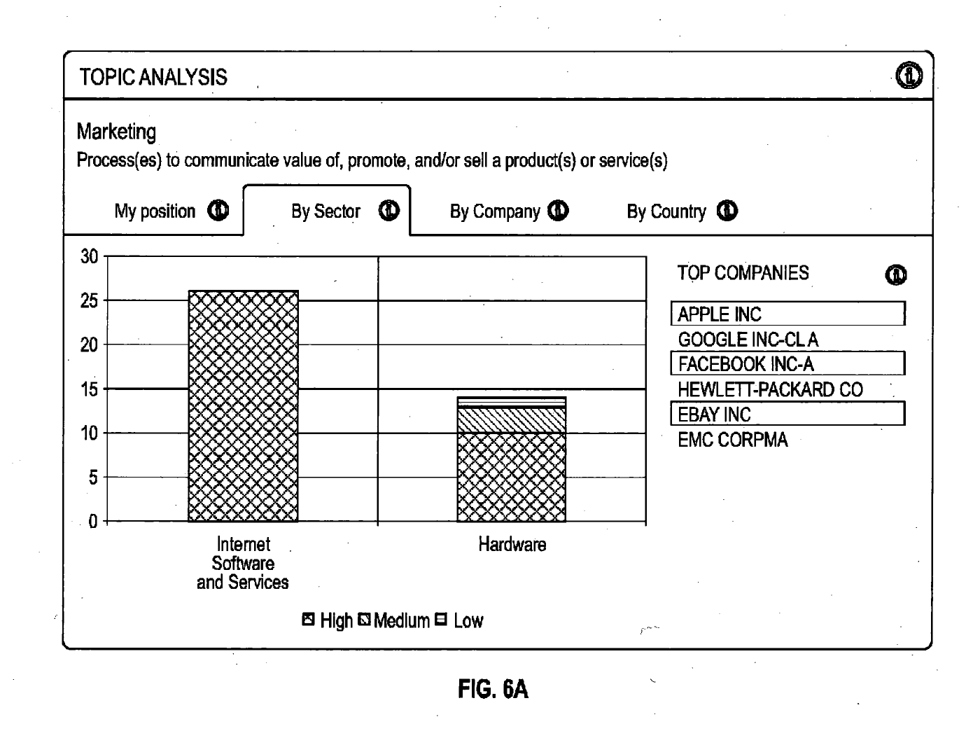

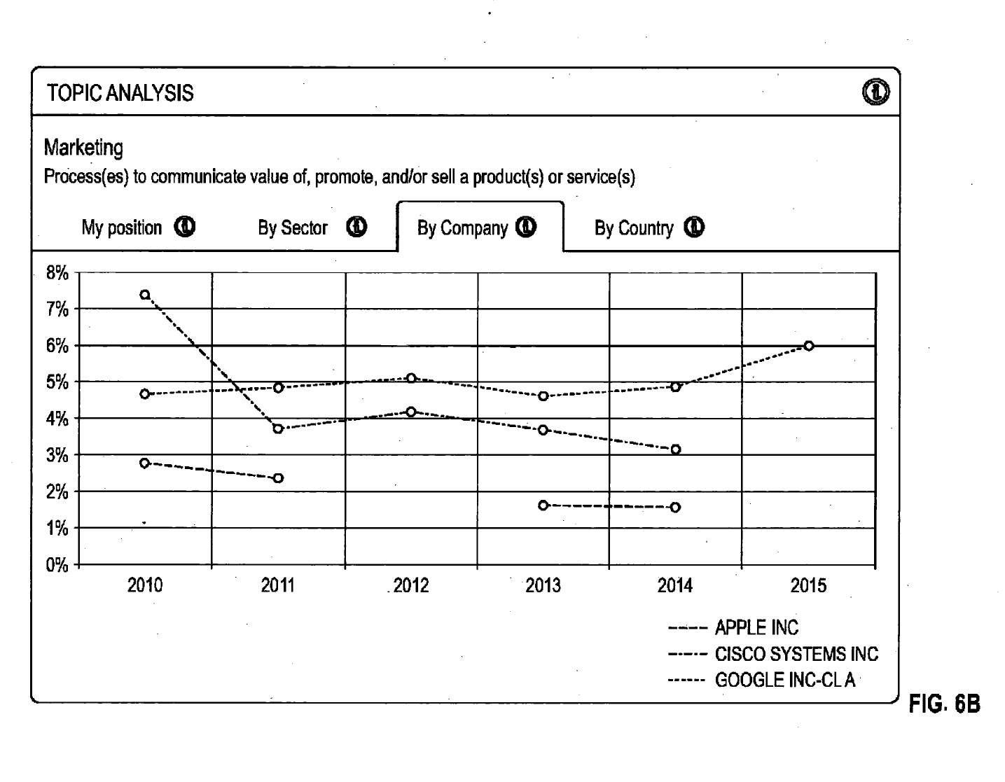

The analysis may be displayed to a user at a user device (e.g. user device 107). Examples of analysis as benchmark output will be described later in this document in relation to FIGS. 5a and 5b, and analysis as topic-based output will be described later in relation to FIG. 6.

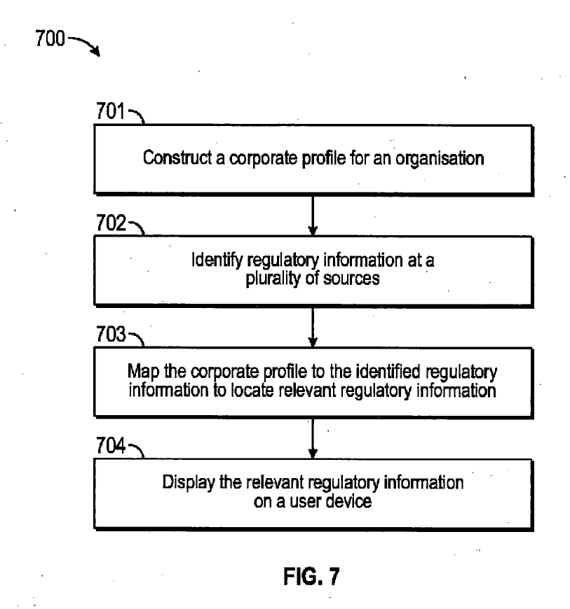

In one embodiment of the invention, the profile constructed for the organisation may be used as a corporate profile to drive a method to locate relevant regulatory information. An example of such a method will be described later in relation to FIG. 7.

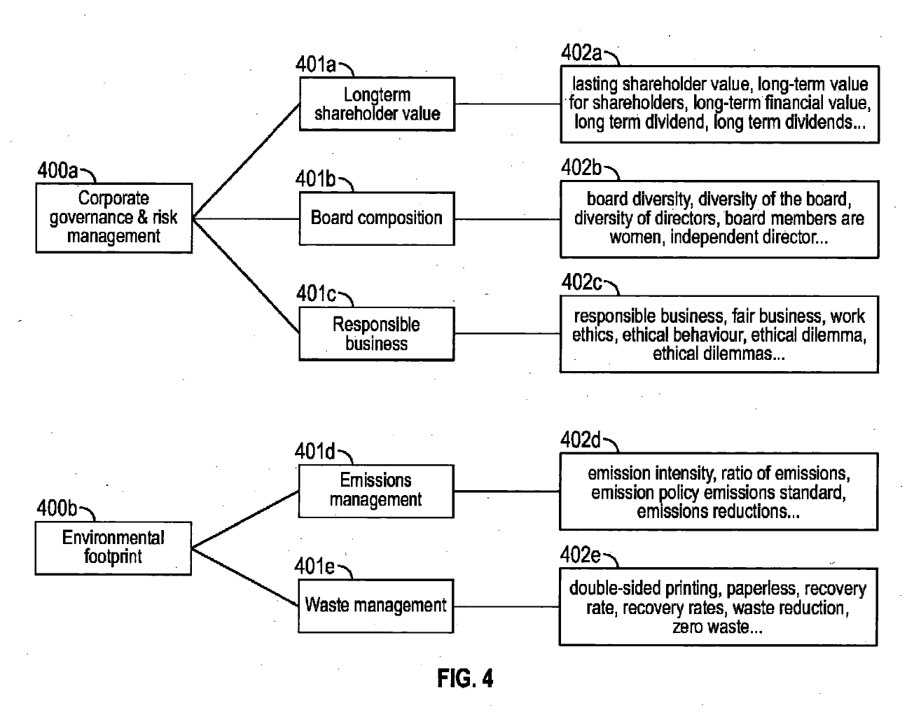

In some embodiments, an asynchronous alert system may monitor organisations or topics for a user. The system may be configured by the user to construct one or more alerts to monitor specific organisations, to monitor organisation sectors, or to monitor organisations which is classified by reference to an ontology (such as shown in FIG. 4) such that one or more topics are deemed relevant to the organisation. In the latter case, the user may specify monitoring of specific topics.

The alert system may in real-time, or periodically, monitor the organisations in accordance with configuration by the user and transmit to the user information about the organisations which trigger the alerts.

Referring to FIG. 3, an ontological method will be described in accordance with an embodiment of the invention.

In step 301, a processor (e.g. processor 102) tokenises text within each data obtained from the plurality of sources. Tokenisation involves splitting up a text using a vocabulary and rules into terms and punctuation.

In step 302, a processor (e.g. processor 102) matches the tokenised text against an ontological framework using a plurality of rules to identify relevant topics within the data.

At least part of the tokenised text may be matched against the terms within the ontological framework. Each matching term is associated with a topic such that occurrences of a matching term within the document are associated with a topic.

The plurality of rules may include any of the following rules:

a) identifying locations within the data to use tokenised text;
b) identifying locations within the data to define weights for the tokenised text; and
c) classifying the located topics on degree of importance.

The plurality of rules may be selected from a larger set of rules. The plurality of rules may be selected based upon a category for the data. For example, the data may be categorised into one of sustainability report, SEC filing, financial annual report, integrated report and Web sites, and each of the categories may be associated with a specific selection of rules.

The number of associations within the document for each topic is used to generate a ranking for the topics from the ontology. One or more of the plurality of rules may identify whether the associations are used to contribute to the ranking based upon the location of the matched terms (e.g. only terms within specific sections of the document contribute).

One or more of the plurality of rules may increase the weight given to certain associations (for example, based upon the location of the matched terms such as terms within a key section of the document).

In one embodiment, multiple matching terms associated with one topic within a single sentence are weighted the same as a single matching term associated with the topic in a sentence.

One or more of the plurality of rules may be used to classify the topics on degree of importance (e.g. high, medium, low importance). For example, if the document has 40 topics, then the top 30% may be classified as high; out of the remaining topics, if the topic has over 4 associations then it is classified as medium; and the remaining topics may be classified as low.

The method is applied to each of the plurality of data as shown at step 303. Each data may represent a document. At step 304, the relevancy of topics across the plurality of data is determined. Some of the data may fall within different categories. For example, one document may be a sustainability report, and another document may be a financial report. In step 304, rules may be utilised based upon the category of the data to determine the weight or relevance of the classification of topics for that document. The further step may, for each topic, classify the topic across the plurality of data based upon any one or combination of the following:

a) where multiple data exist within a category, the highest classification given to that topic across that category;
b) if a predefined category specifies a higher classification for the topic than other categories, the classification of that predefined category (for example, if a financial report classifies a topic as high and a sustainability report classifies a topic as medium than the topic across the reports is classified as high); and/or
c) an average for the classification of the topic across the data.

In one embodiment, the method may include a yet further step of generating a proportional importance for a topic within a data or across a plurality of data may be generated for an entity (for example, a company). This proportional importance may be measured against other entities or against earlier or later generated data to provide a comparison within a cluster of entities or across time respectively.

For illustrative purposes only, FIG. 4 shows a portion of an exemplary ontological framework for use with an embodiment of the invention.

The ontological framework may include a plurality of categories (400a and 400b), each category (400a and 400b) associated with a plurality of topics (401a to 401e), and each topic (401a to 401e) may be associated with a plurality of terms (402a to 402e). The terms (402a to 402e) may be words, phrases or other units of information which can be tokenised within text.

In the example shown in FIG. 4, category 400a is “Corporate governance & Risk management”. This is associated with three topics (401a, 401b, and 401c). Topic 401a is “Longterm shareholder value” and is associated with a plurality of terms 402a (lasting shareholder value, long-term value for shareholders, long-term financial value, long term dividend, long term dividends and others not shown).

FIG. 5a shows an exemplary display of a benchmark analysis generated by the method described in relation to FIG. 2. The display includes a plurality of topics relevant to the profiled organisation and the extent of its relevancy (from low to high), which has been defined by a user or, at least in part, by an automated method during construction of the organisation's profile, against the relevancy of those topics within the plurality of organisations which are peers to the profiled organisation.

FIG. 5b shows an exemplary display of a benchmark analysis generated by the method described in relation to FIG. 2. The display includes a plurality of topics relevant to the profiled organisation and the extent of its relevancy (from low to high), which has been defined by a user or, at least in part, by an automated method during construction of the organisation's profile, against the relevancy of those topics within the plurality of organisations which are peers to the profiled organisation.

FIG. 6a shows an exemplary display of a topic-based analysis generated by the method described in relation to FIG. 2. The display includes a comparison between the relevancy/importance of the topic “Marketing” to organisations in two different sectors.

FIG. 6b shows an exemplary display of a topic-based analysis generated by the method described in relation to FIG. 2. The display includes a comparison over time of the relevancy/importance of the topic “Marketing” to three organisations.

Referring to FIG. 7, a regulatory information location method 700 in accordance with an embodiment of the invention will be described.

In step 701, a corporate profile may be constructed for an organisation. The corporate profile may include any of the following information:
a) Sectors of interest (such as markets and suppliers);
b) Geographies of interest (such as locations of headquarters, markets and suppliers); and
c) Topics of interest.

The corporate profile may be completed, at least in part, automatically by analysing information available about the organisation. Automatically generated elements of the corporate profile may be validated by a user at a user device.

The corporate profile may represent the organisation directly or a hypothetical variation of the organisation. For example, for the latter, the corporate profile may act as a scenario for the organisation.

The corporate profile may be constructed from the profile for the organisation as described in step 204.

In step 702, regulatory information from a plurality of sources is identified. The sources and regulatory information may include initiatives undertaken by governmental actors, initiatives undertaken by market-regulators, initiatives by market associations or non-profit organisations and initiatives issued by industry associations.

Each regulatory information may be associated with metadata or classification information. The association or classification may be manual, automatic, or a combination of both.

The metadata/classification may include the origin of the regulatory information (i.e. governmental, market associations, etc.), date of coming into force, binding force and other status information, sector restriction, name of issuer, etc.

The classification may also include the assignment of relevant topics to each regulatory information. The relevant topics may be selected from an ontological framework such as described in relation to FIG. 4. The relevant topics may be further classified based upon their location within the regulatory information. For example, if the relevant topics appear within a disclosure requirement within the regulatory information, these topics may be classified as “topic within disclosure”, and topics appearing outside the disclosure requirement may be classified as “topics outside disclosure”.

In one embodiment, each regulatory information is classified using an ontological method, such as that described in relation to FIG. 3.

In step 703, the corporate profile is mapped to the identified regulatory information to locate relevant regulatory information.

The relevant regulatory information may be displayed to a user on a user device in step 704.

Where the relevant regulatory information is classified in relation to topics, a summary of topics across the relevant regulatory information may also be displayed to the user.

The method may also include a step of categorising the located regulatory information into categories (for example, directly relevant to the organisation, indirectly relevant, or globally/regionally relevant). The categorising may occur via the use of a plurality of rules. At least some of the rules may utilise data within the corporate profile and/or the organisation's customers/suppliers. The data may include sector, and/or geography.

Examples of rules are shown below:
a) Regulatory information is categorised into directly relevant where the regulatory information is relevant to a country which is also the organisation's headquarters;
b) Regulatory information is categorised into indirectly relevant where the regulatory information is relevant to a country which is also a market served by the organisation or a supplier's location; and
c) Regulatory information is categorised into globally relevant where the regulatory information is not restricted to a specific country.

The relevant regulatory information may include a plurality of regulatory initiatives and the following may be displayed to a user:

a) a title name;
b) a description;
c) the degree of binding force;
d) relevant topics (e.g. assigned during classification) and their classification (e.g. inside or outside disclosure);
e) date of entry into force;
f) date of latest update on the initiative;
g) text on the evolution of the initiative (past and future);
h) issuer's name and type;
i) language of the original text; and
j) sector of application of the given legal instrument and sources

In some embodiments, the user may also search for specific regulatory initiatives.

In some embodiments, an asynchronous alert system may monitor existing regulatory information for a user. The system may be configured by the user to construct one or more alerts to monitor specific regulatory information, to monitor regulatory information identified as relevant in step 703, or to monitor regulatory information which is classified by reference to an ontology (such as shown in FIG. 4) such that one or more topics are deemed relevant to the regulatory information. In the latter case, the user may specify monitoring of specific topics. The monitored regulatory information may be existing regulatory information such that monitoring includes identification of changes, or possible regulatory information such that monitoring includes identification of the creation of regulatory information meeting the configuration specified by the user.

The alert system may in real-time or periodically monitor the regulatory information in accordance with configuration by the user and transmit to the user regulatory information and/or meta-data about the regulatory information that triggers the alerts. The meta-data may be, for example, status information about the regulatory information (e.g. in force, expired, etc.).

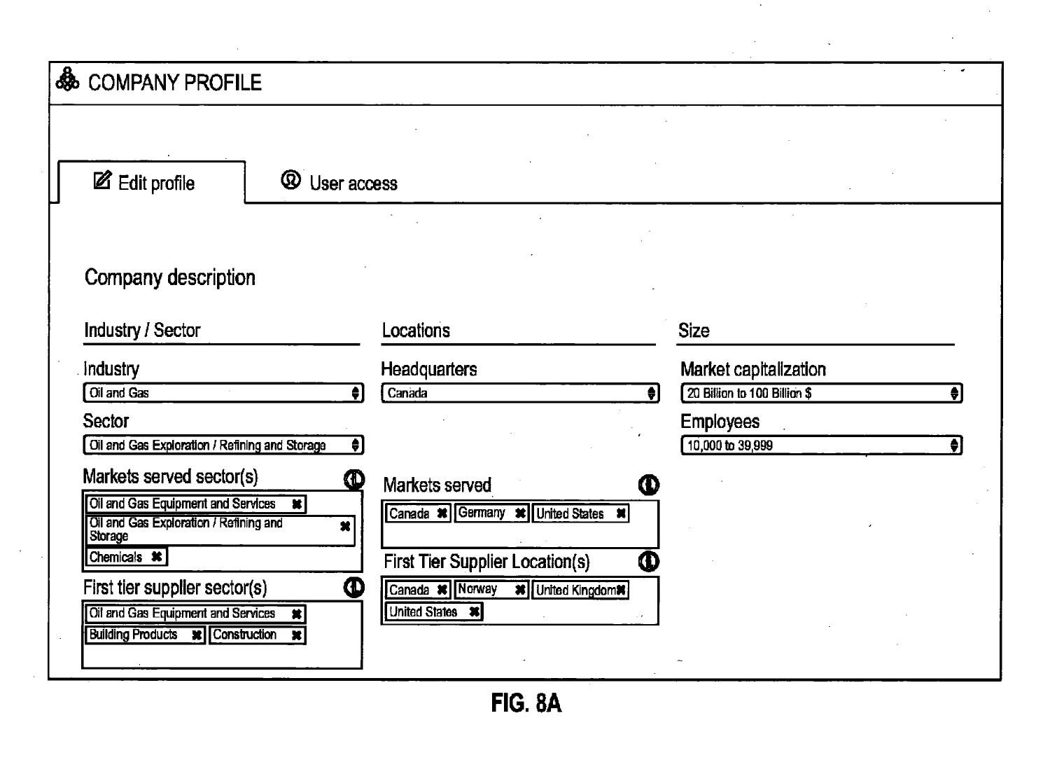

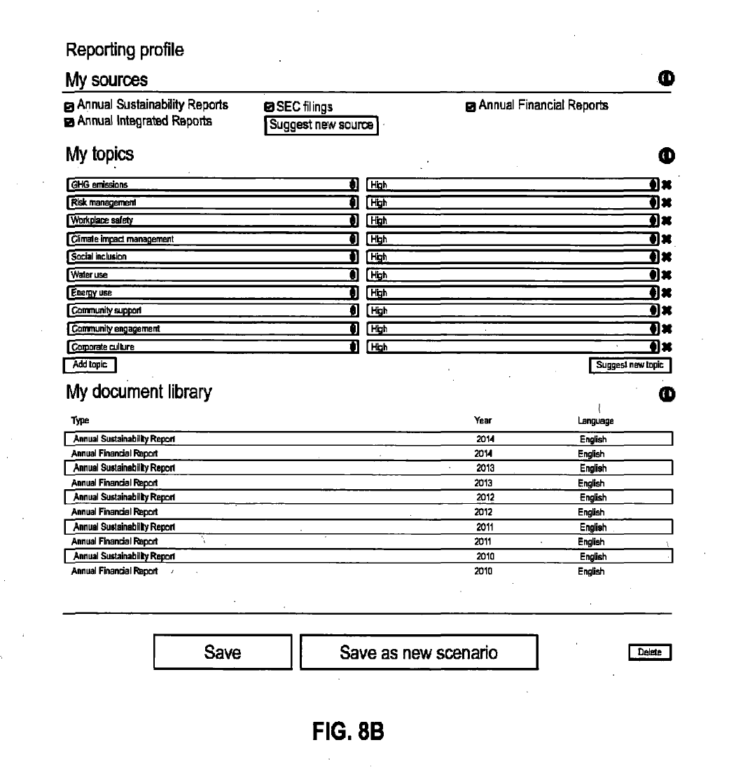

An exemplary user interface for facilitating the definition of information by a user to construct a corporate profile in accordance with an embodiment of the invention is shown in FIGS. 8a and 8b.

In one embodiment, the topics listed may be defined for the profile via the ontological method described in relation to FIG. 3. The user may modify the relevancy weightings given to the topics by the ontological method or delete or add new topics they consider relevant to the organisation's profile (or to the scenario for the organisation).

A potential advantage of some embodiments of the present invention is that existing unstructured data from a plurality of sources can be utilised to construct profiles for organisations and subsequently reports or analysis based upon those profiles; consequently, a better determination of organisations' profiles can be made which leads to more accurate and relevant analysis. Furthermore, the technical solution provided by some embodiments of the invention in processing quickly large quantities of different, and often unstructured, data contributes to the completeness, accuracy, and timeliness of the analysis.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method of providing business intelligence, including:
a processor obtaining data from a plurality of sources for each of a plurality of organisations;
a processor processing the data using an ontological method to generate a report for each organisation; and
a processor using the reports of the organisations to generate analysis.

2. A method as claimed in claim 1, wherein the analysis relates to Financial, Economic, Environmental, Social and/or Governance (ESG) issues.

3. A method as claimed in claim 1, wherein the analysis includes analysing a profiled organisation against one or more of the plurality of organisations.

4. A method as claimed in claim 3, wherein the one or more of the plurality of organisations are selected based upon an overlap between the report of the one or more organisations and a profile of the profiled organisation.

5. A method as claimed in claim 4, wherein the overlap relates to sector and/or geographic overlap.

6. A method as claimed in claim 4, wherein the analysis is a comparison based upon topic.

7. A method as claimed in claim 4, further including:
generating a visualisation for a user interface of the analysis.

8. A method as claimed in claim 4, further including:
Creating the profile.

9. A method as claimed in claim 8, wherein the profile includes a plurality of weighted relevant topics.

10. A method as claimed in claim 9, wherein the plurality of weighted relevant topics are created via the ontological method.

11. A method as claimed in claim 1, wherein the ontological method includes analysis of the data to identify relevant topics.

12. A method as claimed in claim 11, wherein the relevant topics are weighted by importance.

13. A method as claimed in claim 1, wherein the ontological method includes:
at least one processor tokenising text within at least one part of the data; and
at least one processor matching tokenised text against an ontological framework using a plurality of rules to identify relevant topics within the data.

14. A method as claimed in claim 1, wherein the plurality of sources include one or more selected from the set of sustainability reports, SEC filings, financial annual report and integrated reports.

15. A method as claimed in claim 4, further including:
Locating relevant regulatory information for the profiled organisation using the profile.

16. A method as claimed in claim 1, wherein the analysis includes benchmarking.

17. A method as claimed in claim 1, wherein the analysis includes locating relevant organisations by searching within the reports using a user-specified topic.

18. A system for providing business intelligence for an organisation, including:
A communication module configured to obtain data from a plurality of sources about a plurality of organisations;
At least one processor configured to process data from a plurality of sources using an ontological method to form a report for each organisation and using the reports of the organisations to generate analysis; and
A user device configured to display data related to the analysis to a user.

19. (canceled)
